(19) United States
(12) Patent Application Publication
(10) Pub. No.: US 2013/0127961 A1
(43) Pub. Date: May 23, 2013

(54) COMPOSITE MATERIAL AND PROCESS FOR PRODUCING IT

(71) Applicants: Herbert Klein, Arnsberg (DE); Han Kurt Von Werder, Arnsberg (DE); Kurt Nonninger, Ense (DE)

(72) Inventors: Herbert Klein, Arnsberg (DE); Han Kurt Von Werder, Arnsberg (DE); Kurt Nonninger, Ense (DE)

(21) Appl. No.: 13/638,736

(22) PCT Filed: Mar. 29, 2011
(86) PCT No.: PCT/EP2011/054802

§ 371 Date: Feb. 5, 2013

(30) Foreign Application Priority Data
Mar. 30, 2010 (DE) 102010003437.1

(51) Int. Cl. B41J 11/00

(52) U.S. Cl. CPC B41J 11/002
USPC 347/102; 347/105

(57) ABSTRACT

A process for producing a composite material or a precursor thereof includes the steps: (i) printing a support material (A1) with an ink (D) which can be cured by irradiation with light, the support material (A1) (a) being impregnable with a curable resin (B) which after curing is transparent and light-stable, and (b) having a translucency, based on the overall thickness, of 10-95%, preferably 20-90%, more preferably 30-80% for light in the wavelength range of 200-500 nm; (ii) curing the ink (D) by irradiation with light; (iii) impregnating the thus-treated support material (A1) with a curable resin (B) which after curing is transparent and light-stable, and optionally combining the support material (A1) with at least one further support material (A2); and (iv) curing the curable resin (B) simultaneously with or after step (iii); and also relates to the material obtainable by this process.

### INTRODUCTION

The present invention relates to a process for the production of a composite material or a composite-material precursor and the material obtainable by this process. Preferably this invention relates to a process for producing a compressed, laminated composite material comprising on at least one side an image generated by an ink curable with light, preferably UV light, as well as the compressed, laminated composite material producible according to this process.

### STATE OF THE ART

Composite materials, such as are the subject matter of the present invention, are laminate panels or precursors thereof provided in particular with a decorative surface, in which the decorative layer is firmly bonded to the support layer. The latter is achieved, for example, by jointly compressing the decorative layer with at least one support layer, with at least one support layer and/or at least one of the components forming the decorative layer being impregnated with a thermosetting resin. During compression an impregnation of all layers takes place. Owing to the action of heat during the compression, the thermosetting resin is cured, and a multi-layered composite material results which is integrally bonded by the cured resin.

The decorative layer usually comprises, along with a layer printed with the desired decoration, a protective layer and/or a preferably opaque intermediate layer which is located in the finished product between the support material and the decoration-containing layer.

Support materials are papers, non-wovens, but also rigid materials such as wood-material panels, such as e.g. chipboards, MDF panels, glass fiber mats, insulation boards, and mixtures thereof. The compressed and cured composite materials have, along with the desired decoration, surfaces that are scratch-resistant and largely insensitive to thermal stress. They find widespread use in all areas of daily life, in which a decorative surface together with resistance to stress of any kind is desirable. In particular, such composite materials are used for countertops in kitchens and laboratories; for furniture; for built-in furniture and other interior design elements, particularly for office furniture, store fixtures, general interiors of e.g. schools, hospitals, sports facilities, airports and train stations, and in transportation means, such as caravans, railway cars or ships.

The decorative element of the composite materials of this category is provided by insertion of a printed layer into the composite material. To improve the mechanical stability this is often protected by a (transparent) cover layer as the outermost layer of the composite material. The printing of the decorative pattern takes place in the prior art using solvent-containing inks or aqueous inks. The pigments of these inks have after drying a good compatibility with commonly used, thermosetting resins. Such resins are resins on a melamine-basis, urea resins, acrylate or polyurethane dispersions, epoxide resins or water-soluble impregnation resins. Due to this good compatibility, composite materials can be produced with layers that are firmly bonded with each other and which even under severe conditions do not show delamination.

The use of aqueous inks or solvent-containing inks, however, has the disadvantage that the achievable printing speed is limited during the printing of the decorative layer. In particular, often due to evaporation of the water or the solvent, a concentration increase of the ink pigments occurs and thereby a clogging of the ink jet nozzles. Thus, disruptions and interruptions of the printing process keep occurring, and as a whole fast printing speeds cannot be achieved.

Another known method is to print overlay papers free of fillers and to then place these with the printed side onto monochrome decorative paper impregnated with melamine resin, and to compress these with each other. The advantage of this method is that depending on the base paper various decorative colors can be produced with one printing in a rotogravure printing process. The disadvantage of this technique is, however, the large amount of time and the large amount of material required for the production (engraving) of the necessary print rollers, and the associated high costs. For these reasons, in particular, it is not possible to economically produce small lot sizes.

For a commercial production of contour-sharp images in small lots and photo-realistic quality, a technology was developed in which color-receiving layers are printed by means of inkjet digital printing into materials to be printed. An essential component of this method is a compacting of the paper surfaces. The papers compacted in this manner, however, lead to decreased penetration capability of the printed substrates for e.g. impregnating resins, and are very expensive.

One possibility to overcome the disadvantages linked with the aqueous inks and the inks containing solvents would be to use UV-curable inks that do not contain solvents. Since solvents cannot evaporate and a concentration increase of the ink pigments does not take place, the clogging of the ink jet nozzle is avoided.

Substrates printed with UV inks cannot, however, be processed using the technologies from the prior art. The color layer obtained using UV printing is not sufficiently compatible with the known impregnating resins on melamine basis or other bases, as stated above. Therefore, the printed color layer does not form with the impregnating resin in the step of compression and curing of the individual layers any adhesion or only insufficient adhesion.

By this, a delamination at the layer of the composite material supporting the color layer easily occurs when there is mechanical or thermal stress. Also owing to penetration of moisture, the risk of delamination of the printing ink layer from the impregnating resin layer is increased. Such composite materials have therefore insufficient moisture resistance.

In addition, conventional pigmented decorative papers cannot be printed in a satisfactory manner with UV-curable inks since the ink components that are absorbed by the paper lie within the light shade of the pigments and thus are not cured by irradiation with light. This problem can be avoided in the usual decorative papers by applying a color-receiving layer that reduces the lowering of the UV ink. If such substrates are printed using inks cured by light, however, the problem already mentioned arises of insufficient compatibility with the usual impregnating resins.

In light of the process described above and known in the prior art and of the difficulties related therewith, it is an object underlying the present invention to provide a process with which composite materials or composite material precursors can be produced which have sharp contour printed images and which exhibit a good delamination stability in the case of mechanical and thermal stress as well as against moisture. Moreover, the process can be carried out with high speed printing, and therefore the process operates cost effectively.

### SUMMARY

The present invention will be described in more detail below as regards the general and preferred embodiments and using examples and comparative examples. The information given using % is in regard to percent by weight, unless stated otherwise, with “bone dry” denoting “relating to the paper weight in the dry state”, i.e. without paper residual moisture.

The object set out above could be solved by the present invention. More specifically, the object on which the invention is based is solved by a process for the production of a composite material or a composite material precursor (hereinafter for simplicity called “composite material”, and what is meant is both, if nothing else is explicitly specified or if a different meaning is not a logical corollary of the relationship) comprising the steps of:
(i) printing a support material (A1) with an ink (D) curable by irradiation with light, wherein the support material (A1)
   (a) is impregnable with a curable resin (B) which is transparent and light stable after curing, and
   (b) has for light in the wavelength range of 200-500 nm a translucency based on the overall thickness of 10-95%, preferably 20-90%, more preferably comprising 30-80%;
(ii) curing the ink (D) by irradiation with light;
(iii) impregnating the thus treated support material (A1) with a curable resin (B) which is transparent and light-stable after curing, and combining the support material (A1) with at least one additional support material (A2), and
(iv) curing the curable resin (B) simultaneously with or after step (iii);

Preferred embodiments of this process are defined in the attached, dependent process claims.

Furthermore, the object underlying the invention is solved by a composite material obtainable according to the process according to the invention.

### DETAILED DESCRIPTION

According to the process in accordance with the invention, first a support material (A1) is printed with an ink (D) curable by irradiation with light. An inkjet printing process is used here in particular for the production of prints on the basis of digital originals.

### Support Material (A1)

The support material (A1) used according to the invention can be impregnated with a curable resin (B), and has for light in the wavelength range of 200-500 nm, preferably 240-420 nm, and more preferably 250-350 nm, a translucency of 10-95% in relation to the overall thickness of the support material (A1). Preferably this translucency is 20-90%, and more preferably 30-80%. This ensures that the light used for curing the ink (D) can penetrate to a sufficiently deep degree into the support material (A1), by which the components of the printing ink are also cured which have penetrated the deepest into the support material (A1).

Preferred materials for the support material (A1) are papers and non-wovens. What are meant by non-wovens are glass fiber non-wovens, and in particular non-wovens of boron-silicate glass are to be cited as the preferred embodiments. Suitable papers are in particular those which do not contain fillers, or only such fillers that are translucent to light within the above-mentioned wavelength ranges. Irrespective of the presence of such fillers, papers are still preferred that comprise at least 50 wt.-% cellulose fibers, preferably at least 70 wt.-%, and more preferably at least 90 wt.-%.

Particularly suitable are papers having a basis weight of 10-200 g/m². Further preferred basis weights are 15-130 g/m², and more preferably 20-100 g/m².

### Ink (D)

As to the inks (D) that can be used to print the support material (A1), those that are preferably to be mentioned are those which can be cured by irradiation with light in the wavelength range of 200-500 nm. A high quantum yield is preferred since in this case the energy required for curing can be reduced, and the apparatuses used for curing can be dimensioned correspondingly smaller. Preferred is a curability of the resin with light a wavelength of 240-420 nm, more preferably 250-350 nm.

Suitable inks which can be cured in the above-mentioned wavelength ranges are in particular inks on an acrylate basis, inks on a polyester basis, inks on an epoxide basis and inks on an epoxy acrylate basis. One example of such inks curable in the UV range ink is the Rho Roll Ink (Durst Phototechnik AG, IT-39042 Brixen), a pigmented ink on acrylate basis.

Such inks are especially suited for use in inkjet printing. The printing of the support material (A1) takes place according to the invention preferably by means of inkjet printing on the basis of digital image data sets.

Impregnated with Resin (B)

The support material (A1) printed with the ink (D) is impregnated after curing of the ink by irradiation with light with a curable resin (B). This is carried out by directly impregnating the support material with the curable resin, or by overlaying the support material (A1) with at least one additional support material (A2) which is impregnated with a curable resin (B), and compressing said at least two layers in such a manner that an impregnation of the support material (A1) with the resin (B) from the support material (A2) is carried out. According to the invention, a process is also suitable in which the support material (A1) is directly impregnated with the resin (B), and is additionally combined with at least one further resin-impregnated support material (A2) in the manner described above.

The at least one support material (A2) can be selected from a plurality of materials, and preferred are overlay papers, decorative papers, soda kraft papers, non-wovens on synthetic or natural fiber basis, insulation boards, chipboard or plywood boards, glass fiber material, and mixed products therefrom.

According to a particularly preferred embodiment, the printed support material (A1) is combined on one side with a resin-impregnated overlay paper. This side later forms the outer surface of the composite material according to the invention, i.e. the overlay paper forms a transparent protective layer for the printed support material (A1). Preferably, the overlay paper used for this purpose has a basis weight of 10-200 g/m². Moreover, it preferably has a minor content of opaque fillers so that by the impregnation with the curable resin (B) a transparent material results which allows the underlying printed support material (A1) to be easily visible.

The support material (A2) can also be a material which imparts to the resulting composite material primarily volume and strength. In this case, soda kraft papers, non-wovens, insulation boards, chipboard or plywood panels, glass fiber materials and mixed products thereof are preferred. According to one preferred embodiment in accordance with the invention, soda kraft paper is used as support material (A2), in particular such having a basis weight of 40-300 g/m², preferably 80-250 g/m², more preferably 100-200 g/m².

In an alternative embodiment, the support material (A2) is a decorative paper. Such a paper is more or less opaque and therefore shields the composite material according to the invention optically from the layers possibly provided therebelow. The decorative paper may be of any color, but is preferably white or of a light hue, so that print provided thereabove is emphasized in the support material (A1) and/or is reinforced. The decorative paper also has a uniform color without a pattern. Particularly preferred are those decorative papers that are completely opaque and do not lose opacity even when impregnated with the curable resin (B). The basis weight of the decorative paper is typically in the range of 50-150 g/m², preferably 60-120 g/m², more preferably 75-100 g/m².

By combining such a decorative paper as support material (A2) with the printed support material (A2), a composite material is obtained, in which the printed image materializes in front of the preferably monochromatic and homogeneous opaque background of the decorative paper in a particularly aesthetically pleasing manner. Since the support material (A1) has a high degree of transparency for the reasons given above, it cannot be avoided that the layer lying under the support material (A1) is visible in the unprinted areas. In the case of a monochrome decorative paper a certain “background color” can intentionally be adjusted for the printed image on the substrate (A1).

A composite material as according to the invention can also be produced using decorative papers as core layers. Such products can be used most preferably where the cross-section of the composite material forms a visible edge. The decorative paper as the core layer then has the same color as the background of the printed area of the composite material. By a specific selection of the decorative paper used as the core layer further decorative edge effects can be achieved. The resin treatment of the decorative paper in such an application is preferably 50-120% bone dry paper, in particular 60-100%.

In a still further embodiment, overlay papers may be used as core layers, by which in total translucent composite materials are obtained. The resin treatment of the overlay paper is here preferably 50-250% bone dry paper, especially 60-200%.

The basis weight of the decorative paper in these embodiments is usually in the range of 50-200 g/m², preferably 60-150 g/m², more preferably 75-120 g/m², even more preferably 80-100 g/m².

According to the invention, the combination of printed support material (A1) and at least one further support material (A2) can be selected according to preferred embodiments from the combinations of a printed substrate (A1) with (a) an overlay paper, (b) a decorative paper, (c) an overlay paper applied to one side and an overlay paper placed on the other side of the support material (A1), (d) any one of the embodiments (a)-(c) with one or more layers of the above-described support materials for achieving volume and strength.

Furthermore, composite materials are included within the scope of the invention that have on both sides a decorative layer of at least the printed (and impregnated/cured) support layer (A1) and optionally other layers, such as described above. These structures preferably have at least one core layer as the core impregnated material, e.g. one or more layers of also impregnated soda kraft paper, decorative paper or overlay paper, or other materials, as already defined. The decorative layers can be the same on both sides or different from each other.

With any of the embodiments described above, further combinations with additional layers for other purposes can be constructed, which are also included within the scope of the invention.

The curable resin (B) may be any resin, in which the support materials (A1), (A2) and optionally further support materials of the composite material as according to the invention can be impregnated and can be cured with compression of the layers. Preferably, the curable resin (B) is a thermosetting resin.

For the impregnation in the support material, the resin (B) can be present in undiluted form or in diluted form, preferably diluted in the form of a suspension, dispersion or solution in a suitable medium. Particularly preferred are aqueous impregnating resin compositions in which the dilution medium is wholly or predominantly water. In addition to water, if necessary solubility/miscibility improvers miscible with water can be used, for example lower alcohols, aldehydes, ketones, or glycols.

Since the curable resin (B) is impregnated into support materials which are visible in the finished composite material, the resin (B) must be transparent after curing, preferably colorlessly transparent. Moreover, it is desirable that the cured resin (B) is non-fading, i.e. that it does not become discolored over time by light impact.

Particularly preferred are those resins (B) that satisfy the requirements of transparency and light fastness that can be selected from aminoplast resins, in particular melamine resins (e.g. Kauramin® 753, BASF AG); melamine ether resins (e.g. Madurit® SMW 818, INEOS Melamines GmbH, DE-60386 Frankfurt/Main), urea resins, polyester resins, acrylate dispersions (e.g. Plextol® BV 595, PolymerLatex GmbH, DE-45768 Marl), polyurethane dispersions, epoxide resin dispersions, and mixtures thereof.

The composite material as according to the invention can contain also layers that are not visible in the finished product. Examples of this are the core layers which are used to obtain the correct thickness and toughness of the products. Such layers, if they are impregnated as well as the visible layers with a curable resin, can be impregnated, in place of the resin (B) as described above, also with a curable resin (C) which does not have to be transparent, light-stable and/or color-fast. A preferred example of such a resin is the class of phenolic resins.

The present invention comprises also embodiments in which different support materials are impregnated with different curable resins (B) and/or (C), as long as these are compatible with each other and are compressed into a composite material with the delamination properties preferred according to the invention and can be cured.

The composite material according to the invention is produced by providing a support material (A1) comprising a printed image generated by printing with the ink (D) and curing with light, impregnating this printed support material (A1) with a curable resin (B) and curing the resin (B).

In practice, the printed and cured support material (A1) is directly and/or indirectly impregnated via at least one further impregnated support material (A2) with a curable resin and is thereafter cured.

If the printed and cured support material (A1) is directly impregnated and cured, a composite precursor is obtained as a product according to the process, that in the further steps can be processed with other materials to form a composite material.

According to the invention it is preferred, however, to produce the targeted composite material by direct compression and curing of the layers to be bonded together. It is therefore preferred according to the invention to compress and to cure the printed and cured support material (A1) jointly with at least one additional support material (A2). The support material (A1), at least one of the optionally plural other support materials (A2) or also all support materials can be impregnated here with the curable resin (B). Which materials are impregnated with the curable resin (B) and the amount of resin (B) impregnated therein are not critical as long as a composite material is obtained by compressing the composite of the individual support materials, in which all of the layers are impregnated with the curable resin (B) and provided by curing a firmly bonded composite material.

If the printed and cured support material (A1) is impregnated with a curable resin (B), it is preferred according to the invention to impregnate the resin (B) in an amount of 20-500 wt.-%, preferably 30-400 wt.-%, more preferably 40-350 wt.-%, based on the basis weight of support material (A1). For example, in support materials (A1) compressed with a resin-impregnated overlay the resin coating (e.g. a melamine resin) is preferably 60-120% bone dry paper, in particular 70-100%, and in those which are compressed without overlay 80-180% bone dry paper, in particular 100-160%.

The resin coating in unprinted cover overlays amounts preferably to 200-500% bone dry paper, particularly 240-350%, and with soda kraft paper preferably 35-120% bone dry paper, particularly preferably 40-100% bone dry paper, and particularly 45-80%. The upper amounts of resin coating are applied particularly in bonds with not impregnated, printed substrates.

The residual moisture content of the resin-impregnated materials after drying is generally for all of the described materials and for each material to be laminated independent of the other 4-10% (based on the total weight of the impregnated material), preferably 5-9%, more preferably 6-8%.

Further particularly preferred embodiments of the present invention are so-called thin laminates which are obtained by compression of a printed sheet onto a vulcanized fiber sheet or a Vulkament sheet and under an overlay to a having a product thickness of 0.15 to 0.40 mm, preferably 0.2 to 0.35 mm, in particular 0.25-0.30 mm, and so-called compact boards having a thickness of 1-40 mm, preferably 2-30 mm, with the thickness being determined by the thickness and number of layers used as core impregnated material. The core impregnated materials are as a rule soda kraft papers impregnated having a phenolic resin with a paper weight of 60-300 g/m², preferably 120-250 g/m², more preferably 140-200 g/m². These compact boards can comprise decoration on one or on both sides containing the printed support material (A1).

When the process as according to the invention is carried out in such a manner that the one support material layer is impregnated by compression with another resin-impregnated support material layer with the curable resin (B), the compression must be carried out such that sufficient impregnation of the layer not previously impregnated is guaranteed. The parameters available here, in particular compression pressure and duration, but also temperature and the entire available amount of impregnating resin in the material to be compressed, are fundamentally known to the person skilled in the art and can be appropriately adjusted by him on the basis of his expert knowledge. The fundamentals of this technology are described, for example, in the handbook “Kunststoff-Handbuch” [Plastics Handbook] (Ed.: G. W. Becker, D. Braun, W. Woebcken), vol 10 (Duroplaste), Carl Hanser Verlag, second completely revised edition 1988.

If the curable resin (B) is a thermosetting resin, the curing can be carried out by thermal treatment during compression or after compression and after impregnation of all of the layers or simultaneously therewith. This temperature can be adjusted in a suitable manner here during the compression.

The time required for impregnation for said system dependent on the compression pressure is easily evident to the person skilled in the art. The less the pressure the slower the complete impregnation takes. It is also known to the person skilled in the art that thermosetting resins cure more quickly with increasing temperature. Thus, the skilled person will in practice choose conditions in which the impregnation and curing can be performed in a compression step. For this it is necessary that the compression pressure is sufficiently high so that impregnation is completed at the given temperature before the viscosity of the resin has increased owing to the progressing curing such that it is no longer viscous under the given pressure. On the other hand, the temperature must be set such that the curing process does not yet substantially advance until completion of the impregnation, but can be completed in an acceptable time.

According to the invention, the process, with the impregnation and curing being carried out in one step, is carried out by compression at a pressure of 1000-10,000 kPa and at a temperature of 110-220° C. In particular, the temperature can also be varied over the time progression of the compression step. For example, compression can be undertaken to achieve a complete impregnation at a low initial temperature and the curing can be started and completed by a subsequent increase while maintaining thereby the pressure.

The pressure during compression preferred according to the invention is independent of the type of selected curable resin (B) and/or the temperature for the curing in the range of 1.0-10.0 MPa, preferably 1.5-7.0 MPa, more preferably 2.0-5.0 MPa. The temperature for the curing of the resin (B) is to be selected depending on the type of resin used, and is preferably in the range of 110-220° C., more preferably 120-200° C., more preferably 130-180° C.

By suitable choice of compression conditions within the ranges described above, the impregnation and curing can be carried out generally within a period of 5 seconds to 120 minutes, preferably 10 seconds to 90 minutes, more preferably 20 seconds to 60 minutes. According to the invention, it is also possible to achieve the impregnation of the individual layers of the composite material according to the invention by compression, and to then carrying out the curing under reduced compression pressure. The temperatures to be used in this case are in the same range as described above.

The skilled person is readily familiar with the fact that according to the invention different laminating and compression methods and apparatus can be used, and with these each use different conditions. Therefore narrow, preferred compression conditions cannot be specified. The conditions that apply for different processes and/or apparatus are, however, known to those skilled in the art and are also easy to determine for the present purpose as part of common general knowledge. However, the following preferred ranges can be provided for some methods/apparatus for the essential method parameters of pressure, temperature and compression time:

Lamination in daylight presses: 1.0-10.0 MPa, 120-160° C., 10-90 minutes depending on the floor occupancy, recooling to 70° C. under pressure.

Laminating in Conti presses: 1.0 to 7.0 MPa, 150-210° C., 10-60 seconds, recooling to 50-160° C. under pressure optional.

Lamination in short cycle presses HPL: 3.0 to 10.0 MPa, 140-180° C., 20-240 seconds, occupancy 1 or 2 HPL/compression step.

Lamination in short cycle presses by direct coating: 1.0-5.0 MPa, 140-210° C., 5-60 seconds (compressing of individual plates)

### EXAMPLES

The products obtained in the examples and comparative examples were tested for their thermal and mechanical delamination stability and moisture resistance. The sample was thereby exposed to the following conditions prior to evaluation:
Test 1: heating with an IR irradiator (test according to DIN EN 438) to a specific temperature X, but at least to 180° C., and further heating for a certain period Y after reaching the temperature X.
Test 2: storing in a pre-heated drying cabinet set at 180° C. for 20 minutes, according to DIN EN 438.
Test 3: Boiling-water/water-vapor test according to DIN EN 438.

### Example 1

An overlay paper (basis weight 70 g/m², longitudinal suction height according to DIN ISO 8787-1: 56.0 mm/10 min, pH 6.30) was printed and cured without color-receiving layer with a UV-curable inkjet ink (Rho Roll Ink). The coverage of the print was 70-90%. A contour-sharp image with sufficient color saturation was obtained.

The printed paper was impregnated and dried using a melamine-resin impregnation solution (I) of the composition shown below. The resulting impregnated material (1-1) had a melamine resin coating of 90% bone dry paper and a residual moisture content of 6.7% after drying.

### Impregnating Solution (I):

| | | |
|---|---|---|
| melamine resin: | Kauramin ® 753 | 54% |
| wetting agent: | Alton ® 959 | 0.7% |
| separating agent: | Alton ® 856 | 0.4% |
| curing agent | | 0.35% |
| water | | ad. 100% |

As curing agent, a 65% aqueous solution of morpholine salt of p-toluene sulfonic acid was used. The pH of the ready-to use impregnation solution was 7.8. With the same impregnating solution (I) an unprinted overlay paper was impregnated and dried (basis weight 28 g/m²). The resulting impregnated material (2) had a melamine resin coating of 320% bone dry paper and residual moisture after drying of 4.8%.

A white monochromatic decorative paper (basis weight 80 g/m²) was also impregnated and dried with the impregnating solution (I). The resulting impregnated material (3) had a melamine resin coating of 90% bone dry paper and residual moisture after drying of 6.4%.

Furthermore, a soda kraft paper (paper weight 160 g/m²) was impregnated and dried using a standard solution of phenolic resin (resin content 63%) for decorative laminates (Prefer® 70 5573 L, Dynea Erkner GmbH, DE-15537 Erkner). The resulting impregnated material (4) had a phenolic resin coating of 45% bone dry paper and residual moisture content of 5.8% after drying.

Three layers of impregnated material (4) and one layer each of the impregnated material (3), (1-1) and (2) were overlaid in this order and compressed with each other at a pressure of 10 N/mm² and at a temperature of 140° C. for 20 minutes. It was then cooled under the same pressure to 70° C.

### Example 2

An overlay paper (basis weight 40 g/m², longitudinal suction height according to DIN ISO 8787-1: 78.0 mm/10 min, pH 6.10) without color-receiving layer was cured as in Example 1 with a UV-curable inkjet ink (coverage of the print 70-80%) and then impregnated and dried with the impregnation solution (I). The resulting impregnated material (1-2) had a melamine resin coating of 90% bone dry paper and residual moisture content of 6.7% after drying.

In the same manner as in Example 1a compressed product was then prepared.

### Example 3

In the same manner as in Example 1, a compressed product was produced with the difference that the printed and cured overlay paper was not impregnated with the melamine resin impregnation solution (I).

### Tests and Results

The products obtained in Examples 1 to 3 were tested as described above. The results were as follows:
Test 1: (X=190° C., Y=10 sec): no delamination.
Test 2: no delamination.
Test 3: no blistering after steam-vapor test and boiling-water test good moisture resistance).

It was also shown after trimming of the products using a disk saw that there was no chipping at the cut edges, and in the bending tests according to DIN EN ISO 178 the product broke without the decorative layer chipping off. The products therefore showed good thermal and mechanical delamination stability and moisture resistance.

### Comparative Example 4

A commercially available digital printing paper having a color-receiving layer (Technocell® MPK 9653; basis weight 100 g/m², ash content about 40%; pH 6.10) was printed with UV-curable inkjet ink (Rho Roll Ink). The coverage of the print was 70-80%. The ink was cured by UV radiation. A contour-sharp image with sufficient color saturation was obtained.

The printed paper was impregnated and dried with the melamine resin impregnation solution from Example 1. The resulting impregnated material (1-4) had a melamine resin coating amount of 80% bone dry paper and residual moisture content of 6.4% after drying.

Three layers of the impregnated material (4) from Example 1, one layer impregnated material (1-4) and one layer impregnated material (2) from Example 1 were overlaid in this order and compressed as described in Example 1.

The resulting product was tested as described above. The results were as follows:
Test 1: the product delaminated as soon as when a surface temperature of 150° C. was reached.
Test 3: Blistering after water vapor test (i.e. poor moisture resistance).

### Comparative Example 5

A printing base paper (basis weight 72 g/m², ash content 38%, pH-value 6.3) was provided with a coating having a self-crosslinking acrylate dispersion (Plextol® 595 BV) with an ink-receiving layer. The resulting paper had a dry coating on the ink-receiving layer of 10 g/m² and a residual moisture content of 5.6%.

The paper was printed with an UV-curing inkjet ink. The coverage of the print was 70-80%. The ink was cured by UV radiation. A contour-sharp image with sufficient color saturation was obtained.

The printed paper was impregnated with the melamine resin impregnation solution from Example 1 and dried. It was necessary thereby to pass the coated and printed surface of the paper as the underside through the resin bath to achieve sufficient resin absorption and for the entrapped air to escape. The resulting impregnated material (1-5) had a melamine resin coating of 80% bone dry paper and a residual moisture content of 6.2% after drying.

In the same manner as Comparative Example 4 the impregnation material (1-5) was superimposed with the impregnated materials (2) and (3) from Example 1 and compressed.

The resulting product was tested as described above. The results were as follows:
Test 1: (X=180° C., Y=3 sec): onset of delamination.
Test 2: onset of delamination.
Test 3: blistering after water-vapor test (i.e. poor moisture resistance).

Further the overlay (impregnated material (2)) peeled off as early as upon the onset of light bending stress and after trimming at the cut edges from the printed substrate. The composite was far better at unprinted areas, but still not good enough.

### Comparative Example 6

The printing base paper from Comparative Example 5 was printed without color-receiving layer with a UV-curable inkjet ink.

The ink was absorbed by the paper web. A contour-sharp image with sufficient color saturation could not be achieved. The ink could not be cured by UV radiation since significant portions of the ink were in the light shade of the pigments of the printing base paper.

### Comparative Example 7

In the same manner as Comparative Example 4, a compressed product was produced, with the difference that the digitally printed paper was printed with an aqueous ink (Long Life Ink, DicoJET GmbH, DE-63654 Büdingen) instead of the UV-curable inkjet ink used in Comparative Example 1.

The resulting product was tested as described above. The results were as follows:
Test 1: (190° C., 10 sec): no delamination.
Test 2: no delamination.
Test 3: no blistering after water vapor test and boiling-water test (i.e. good humidity resistance).

It was also found after trimming the product by means of a disk saw that no chipping occurred at the cut edges, and in the bending tests according to DIN EN ISO 178 the product broke without the decorative layer chipping off. The products also showed good thermal and mechanical delamination stability and moisture resistance.

Comparative Example 7 shows that on the printing base paper the combination of UV-curable ink and the color-receiving layer required for this were also responsible to a significant extent for the delamination and insufficient moisture resistance of the compressed products.

### Comparative Example 8

As in Example 1, a melamine-resin-impregnated overlay paper was produced, with the difference that it exhibited a melamine resin coating amount of 380% bone dry paper (impregnated material 2-8). The printed and cured digital printing paper from Comparative Example 4 was compressed without impregnation with melamine resin between two layers of impregnated material 2-8 (heating from room temperature to 150° C. in 5 min., maintaining this temperature for 15 min. and cooling to 60° C. in 10 min., at a pressure of 10 N/mm²).

The resulting compressed intermediate product was placed on the three layers of impregnated material (4) from Example 1 and compressed as described in Example 1.

The resulting product was tested as described above. The results were as follows:
Test 1: The product delaminated as early as when a surface temperature of 80° C. was reached.
Test 3: Blistering after water-vapor test and the water-boiling test (i.e. poor resistance to moisture).

Furthermore, the cover overlay chipped off from the printing ink in the bending test according to DIN EN ISO 178. The product therefore showed poor mechanical delamination stability.

1. A process for producing a composite material or a precursor thereof, comprising the steps of:
(i) printing a support material (A1) with an ink (D) curable by irradiation with light, wherein the support material (A1)
(a) is impregnable with a curable resin (B) which is transparent and light-stable after curing, and
(b) has for light in the wavelength range of 200-500 nm a translucency based on the overall thickness of 10-95;
(ii) curing the ink (D) by irradiation with light;
(iii) impregnating the support material (A1) treated such with a curable resin (B) which is transparent and light-stable after curing, and
(iv) curing the resin (B) simultaneously with or after step (iii).

2. The process according to claim 1, wherein the ink (D) is an ink which is curable by irradiation with UV light in the wavelength range of 200-500 nm.

3. A process according to claim 1, wherein the support material (A1) is selected from
paper, and
non-wovens.

4. A process according to claim 3, wherein the support material (A1) is a paper comprising at least 50 wt.-% cellulose fibers.

5. A process according to claim 3, wherein the support material (A1) is a paper having a basis weight of 10-200 g/m².

6. A process according to claim 1, wherein the UV-curing ink is selected from at least one of a group of: inks on acrylate basis, inks on polyester basis, inks on epoxide basis and inks on epoxy acrylate basis.

7. A process according to claim 1, wherein the curable resin (B) is selected from at least one of a group of: aminoplast resins; melamine resins; melamine ether resins; urea resins, acrylate dispersions and polyurethane dispersions, epoxide resin dispersions, water-soluble impregnating resins, and mixtures thereof.

8. A process according to claim 1, wherein step (iii) is performed by
(iii-a) direct impregnation of the support material (A1) with a curable resin (B) and/or
(iii-b) superposing the carrier material (A1) with a further carrier material (A2) which is impregnated with a curable resin (B) and pre-dried, on at least one side of the support material (A1) and compression of the resulting composite.

9. A process according to claim 8, wherein the at least one support material (A2) is selected from at least one of a group of: overlay papers, soda kraft papers, decorative papers, non-wovens based on synthetic or natural fibers, insulation panels, chipboard or plywood panels, glass fiber materials and mixed products of these materials.

10. A process according to claim 9, wherein the at least one support material (A2) is an overlay paper having a basis weight of 10-200 g/m².

11. A process according to claim 8, comprising at least the step (iii-b), and wherein step (iv) is carried out by compressing at a pressure of 1000-10,000 kPa and at a temperature of 110-220° C.

12. A process according to claim 11, wherein step (iv) is carried out by compressing at a pressure of 1000-10,000 kPa.

13. A process according to claim 11, wherein step (iv) is carried out by compressing at a temperature of 120-200° C.

14. A process according to claim 11, wherein step (iv) is carried out by compression for a period of 5 seconds to 120 minutes.

15. A process according to claim 1, wherein the support material (A1) is impregnated with resin in an amount of 20-500 wt.-%, based on the surface weight of the support material (A1).

16. A composite material or precursor thereof, which is printed with an ink (D) curable by irradiating with light, and comprising a support material (A1) impregnated with a transparent and light-stable resin (B).
